(19) United States
(12) Patent Application Publication
(10) Pub. No.: US 2010/0076755 A1
(43) Pub. Date: Mar. 25, 2010

(54) DECODING APPARATUS AND AUDIO DECODING METHOD

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/516,139

(22) PCT Filed: Nov. 28, 2007
(86) PCT No.: PCT/JP2007/072940

§ 371 Date: May 22, 2009

(30) Foreign Application Priority Data
Nov. 29, 2006 (JP) 2006-322338

(51) Int. Cl. G10L 19/00

(52) U.S. Cl. 704/220; 704/E19.001

(57) ABSTRACT

A decoding apparatus that uses a less number of hierarchical layers and a less amount of calculation to obtain a decoded signal having a high quality in terms of audibility. In the decoding apparatus, a first layer decoding part (152) decodes a first layer encoded data. A second layer decoding part (153) decodes a second layer encoded data. An adding part (154) adds together a composite signal outputted from the first layer decoding part (152) and a composite signal outputted from the second layer decoding part (153). A band expanding part (155) uses a band expansion encode data to perform a band expansion of the high frequency components of the composite signal outputted from the first layer decoding part (152). A filter (156) filters the composite signal obtained by the band expanding part (155), thereby extracting the high frequency components. An adding part (157) adds the high frequency components outputted from the filter (156) to the composite signal outputted from the adding part (154), thereby obtaining an ultimate decoded signal.

### TECHNICAL FIELD

The present invention relates to a decoding apparatus and decoding method for decoding a signal that is encoded using a scalable coding technique.

### BACKGROUND ART

In mobile communication, it is necessary to compress and encode digital information such as speech and images to efficiently utilize radio channel capacity and a storing medium, and, therefore, many encoding/decoding schemes have been developed so far.

Among these techniques, performance of the speech coding technique has significantly improved thanks to the fundamental scheme “CELP (Code Excited Linear Prediction)” of ingeniously applying vector quantization by modeling the vocal tract system. Further, performance of a sound coding technique such as audio coding has improved significantly thanks to transform coding techniques (MPEG standard ACC, MP3 and the like).

Further, recently, scalable codecs that cover from speech to audio are being developed and standardized (ITU-T SG16 WP3) to aim for full IP, seamless, broadband radio communication. Almost all of these codecs cover frequency bands that are layered and encode a quantization error in a lower layer, in an upper layer.

Patent Document 1 discloses a fundamental invention for layer coding for encoding a quantization error in a lower layer, in an upper layer and a method for encoding a wider frequency band from a lower layer toward an upper layer using conversion of the sampling frequency.

However, in a layer in which the sampling frequency increases significantly, the frequency band which must be encoded widens suddenly. Therefore, although band sensation improves, there is a problem that noise increases, thereby deteriorating sound quality.

For solution to this problem, a technique which combines a band extension technique such as MPEG4 standard SBR (Spectrum Band Replication) with the scalable codec is known. The band extension technique refers to copying low frequency band components decoded in a lower layer based on information about a comparatively small number of bits and pasting them in a higher frequency band.

According to this band extension technique, even if coding distortion is significant, band sensation can be produced with a small number of bits by the band extension technique, so that it is possible to maintain perceptual quality matching the number of bits.

Patent Document 1: Japanese Patent Application Laid-Open No. HEI8-263096

### DISCLOSURE OF INVENTION

### Problems to be Solved by the Invention

Here, if this band extension technique is used, the speech decoding apparatus requires complex processing, including performing quadrature conversion of speech signals in the frequency domain, then copying complex spectra of low frequency components to high frequency components and further performing quadrature inversion of the speech signals into time domain speech signals, thus requiring a significant amount of calculation. Further, the speech encoding apparatus needs to transmit information for band extension (i.e. code), to the speech decoding apparatus.

If the band extension technique is simply combined with the scalable codec, the speech decoding apparatus requires the above complex processing on a per layer basis and the amount of calculation therefore becomes enormous. Furthermore, the speech encoding apparatus needs to transmit information for band extension on a per layer basis.

It is therefore an object of the present invention to provide a decoding apparatus and decoding method for acquiring a perceptually high-quality decoded signal with a small amount of calculation and a small number of bits.

### Means for Solving the Problem

A decoding apparatus according to the present invention that generates a decoded signal using two items of encoded data, the two items of the encoded data being acquired by encoding a signal including two frequency domain layers on a per layer basis, employs a configuration including: a first decoding section that decodes the encoded data of a lower layer to generate a first synthesized signal; a second decoding section that decodes the encoded data of an upper layer to generate a second synthesized signal; an adding section that adds the first synthesized signal and the second synthesized signal to generate a third synthesized signal; a band extending section that extends a band of the first synthesized signal to generate a fourth synthesized signal; a filtering section that filters the fourth synthesized signal to extract predetermined frequency components; and a processing section that processes predetermined frequency components of the third synthesized signal using the frequency components extracted by the filtering section.

A decoding method according to the present invention for generating a decoded signal using two items of encoded data, the two items of the encoded data being acquired by encoding a signal including two frequency domain layers on a per layer basis, includes: decoding the encoded data of a lower layer to generate a first synthesized signal; decoding the encoded data of an upper layer to generate a second synthesized signal; adding the first synthesized signal and the second synthesized signal to generate a third synthesized signal; extending a band of the first synthesized signal to generate a fourth synthesized signal; filtering the fourth synthesized signal to extract predetermined frequency components; and processing predetermined frequency components of the third synthesized signal using the frequency components extracted as a result of the filtering.

### ADVANTAGEOUS EFFECT OF THE INVENTION

According to the present invention, it is possible to acquire a perceptually high-quality decoded signal with a small amount of calculation and a small number of bits. Moreover, according to the present invention, it is not necessary to transmit information for band extension in a coder of an encoding apparatus for an upper layer.

### BRIEF DESCRIPTION OF DRAWINGS

FIG. 1 is a block diagram showing a configuration of a speech encoding apparatus that transmits encoded data to a speech decoding apparatus according to an embodiment of the present invention;

FIG. 2 is a block diagram showing a configuration of the speech decoding apparatus according to an embodiment of the present invention; and

FIG. 3 specifically illustrates processings of the speech decoding apparatus according to an embodiment of the present invention.

### BEST MODE FOR CARRYING OUT THE INVENTION

Hereinafter, an embodiment of the present invention will be explained with reference to the accompanying drawings. With the present embodiment, a speech encoding apparatus and speech decoding apparatus will be explained as an example of a encoding apparatus and decoding apparatus. Further, in the following explanation, encoding and decoding are performed in layers using the CELP scheme. Further, in the following explanation, a scalable coding technique for two layers formed by the first layer of the lower layer and the second layer of the upper layer will be employed as an example.

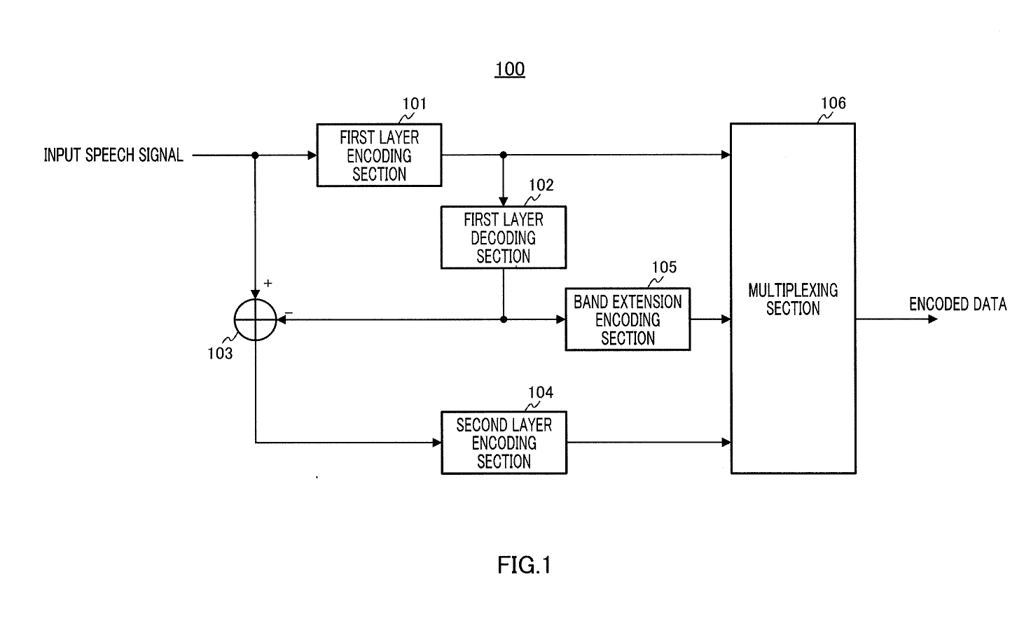

FIG. 1 is a block diagram showing a configuration of a speech encoding apparatus that transmits encoded data to a speech decoding apparatus according to the present embodiment. In FIG. 1, speech encoding apparatus 100 has first layer encoding section 101, first layer decoding section 102, adding section 103, second layer encoding section 104, band extension encoding section 105 and multiplexing section 106.

In speech encoding apparatus 100, a speech signal is inputted to first layer encoding section 101 and adding section 103. First layer encoding section 101 encodes information about speech of the low frequency band alone to suppress noise accompanied by coding distortion, and outputs the resulting encoded data (hereinafter “first layer encoded data”) to first layer decoding section 102 and multiplexing section 106. When time domain encoding such as CELP is performed, first layer encoding section 101 performs down-sampling before encoding, decimates samples and performs encoding. Further, when frequency domain encoding is performed, first layer encoding section 101 converts an input speech signal in the frequency domain and then encodes the low frequency components alone. By encoding this low frequency band alone, it is possible to reduce noise even when encoding is performed at a low bit rate.

First layer decoding section 102 performs decoding, which supports the encoding in first layer encoding section 101, with respect to the first layer encoded data, and outputs the resulting synthesized signal to adding section 103 and band extension encoding section 105. Further, if down-sampling is used in first layer encoding section 101, the synthesized signal which is inputted to adding section 103 is up-sampled in advance to match with the sampling rate for the input speech signal.

Adding section 103 subtracts the synthesized signal outputted from first layer decoding section 102, from the input speech signal, and outputs the resulting error components to second layer encoding section 104.

Second layer encoding section 104 encodes the error components outputted from adding section 103 and outputs the resulting encoded data (hereinafter “second layer encoded data”) to multiplexing section 106.

Band extension encoding section 105 performs encoding using the synthesized signal outputted from first layer decoding section 102 to fill perceptual band sensation by means of the band extension technique, and outputs the resulting encoded data (hereinafter “band extension encoded data”) to multiplexing section 106. Further, if down-sampling is used in first layer encoding section 101, encoding is performed such that a signal is up-sampled and appropriately extended as high frequency components.

Multiplexing section 106 multiplexes the first layer encoded data, second layer encoded data and band extension encoded data and outputs them as encoded data. The encoded data outputted from multiplexing section 106 is transmitted to the speech decoding apparatus through channels such as air, transmission line, recording medium and so on.

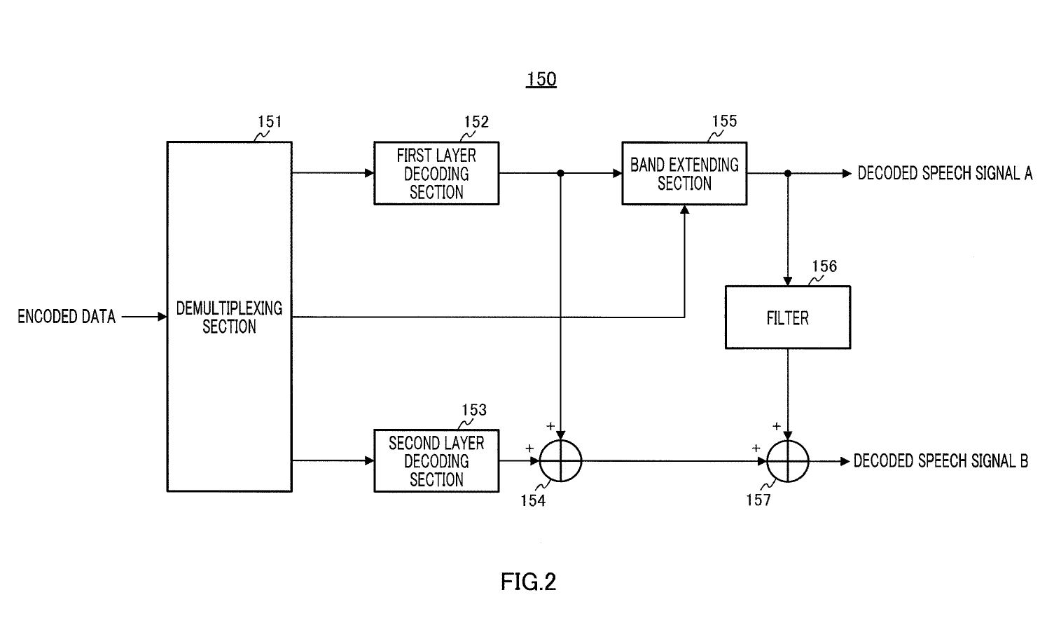

FIG. 2 is a block diagram showing a configuration of the speech decoding apparatus according to the present embodiment. In FIG. 2, speech decoding apparatus 150 receives encoded data transmitted from speech encoding apparatus 100 as input, and has demultiplexing section 151, first layer decoding section 152, second layer decoding section 153, adding section 154, band extending section 155, filter 156 and adding section 157.

Demultiplexing section 151 demultiplexes input encoded data to the first layer encoded data, second layer encoded data and band extension encoded data, and outputs the first layer encoded data, second layer encoded data and band extension encoded data, to first layer decoding section 152, second layer decoding section 153 and band extending section 155, respectively.

First layer decoding section 152 performs decoding, which supports the encoding in first layer encoding section 101, with respect to the first layer encoded data, and outputs the resulting synthesized signal to adding section 154 and band extending section 155. Further, if down-sampling is used in first layer encoding section 101, the synthesized signal inputted to adding section 154 is up-sampled in advance to match the sampling rate for the input speech signal in encoding apparatus 100.

Second layer decoding section 153 performs decoding, which supports the encoding in second layer encoding section 104, with respect to second layer encoded data, and outputs the resulting synthesized signal to adding section 154.

Adding section 154 adds the synthesized signal outputted from first layer decoding section 152 and the synthesized signal outputted from second layer decoding section 153, and outputs the resulting synthesized signal to adding section 157.

Band extending section 155 performs band extension for the high frequency components of the synthesized signal outputted from first layer decoding section 152, using band extension encoded data, and outputs the resulting decoded speech signal A to filter 156. The part of the band extended by band extending section 155 includes the signal related to perceptual high band sensation. This decoded speech signal A acquired in band extending section 155 is a decoded speech signal acquired in the lower layer and can be used when speech is transmitted at a low bit rate.

Filter 156 filters decoded speech signal A acquired in band extending section 155, extracts the high frequency components and outputs the high frequency components to adding section 157. This filter 156 is a high pass filter that passes only the components of higher frequencies than a predetermined cutoff frequency.

Further, the configuration of filter 156 may be an FIR (Finite Impulse Response) type or IIR (Infinite Impulse Response) type. Further, with the present embodiment, the high frequency components acquired in filter 156 are only added to the synthesized signal outputted from adding section 154, so that special limitation needs not to be set upon the phase or ripple. Consequently, filter 156 may be a high pass filter of low delay, which is generally designed.

The cutoff frequency of filter 156 is set in advance at a level in which the frequency components of the synthesized signal outputted from adding section 154 become weak. For example, there are cases where, on the encoding side, the sampling rate of the input speech signal is 16 kHz (the upper limit of the frequency band is 8 kHz) and first layer encoding section 101 performs encoding by down-sampling the frequency of the input speech signal to 8 kHz sampling rate (the upper limit of the frequency band is 4 kHz), and, on the decoding side, the frequency components of the synthesized signal acquired in adding section 154 become weaker from around 5 kHz and high band sensation is not sufficient. In these cases, characteristics of the decoding side are designed such that the cutoff frequency of filter 156 is set to about 6 kHz, the side lobe moderately falls to the low band and the frequency components of the synthesized signal become close to the frequency components of the input signal on the encoding side by means of addition from adding section 157.

Adding section 157 adds the high frequency components acquired in filter 156 to the synthesized signal outputted from adding section 154 and acquires decoded speech signal B. By filling this decoded speech signal B with the high frequency components, it is possible to produce high band sensation and perceptually high-quality sound.

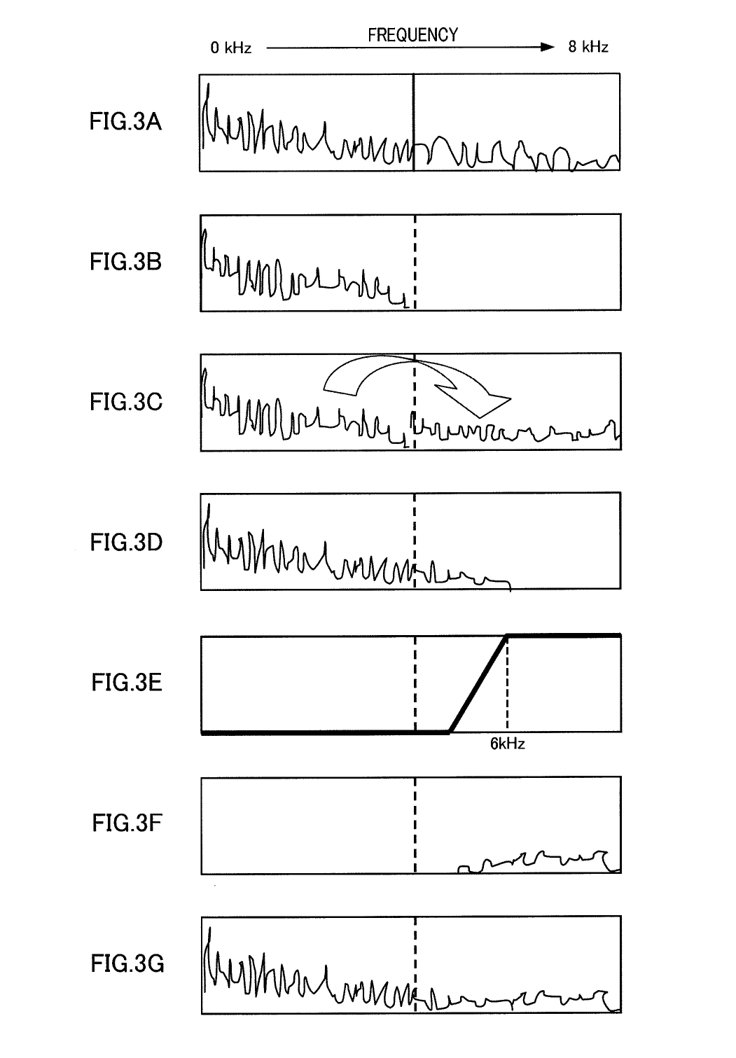

Next, processings of the speech decoding apparatus according to the present embodiment will be explained in detail using FIG. 3. In FIG. 3, the horizontal axis refers to the frequency and the vertical axis refers to the spectral components. Further, in FIG. 3, a case will be shown where the sampling rate of the input speech signal on the encoding side is 16 kHz (the upper limit of the frequency band is 8 kHz) and first layer encoding section 101 performs encoding by down-sampling the frequency of the input speech signal to 8 kHz sampling rate (the upper limit of the frequency band is 4 kHz) which is half of input speech signal.

FIG. 3A shows the spectrum of the input speech signal on the encoding side after down-sampling. Further, FIG. 3B shows the spectrum of the synthesized signal outputted from first layer decoding section 102 on the encoding side. With the present example, the input speech signal is down-sampled to 8 kHz sampling rate and includes the frequency components only up to 8 kHz as shown in FIG. 3A. As shown in FIG. 3B, the synthesized signal outputted from first layer decoding section 102 includes the frequency components only up to 4 kHz which is half of 8 kHz.

FIG. 3C shows the spectrum of decoded speech signal A outputted from band extending section 155 on the decoding side. As shown in FIG. 3C, in band extending section 155, the low frequency components of the synthesized signal outputted from first layer decoding section 152 are copied and pasted in the high frequency band. The spectrum of the high frequency components generated in this band extending section 155 is substantially different from the spectrum of the high frequency components of the input speech signal shown in FIG. 3A.

FIG. 3D shows the spectrum of the synthesized signal outputted from adding section 154. As shown in FIG. 3D, as a result of encoding and decoding of the second layer, the spectrum of the low frequency components of the synthesized signal outputted from adding section 154 becomes similar to the spectrum of the input speech signal shown in FIG. 3A. However, if encoding is performed in the second layer such that noise is not produced, a speech signal to input generally includes the great low frequency components and the coder tries to encode the low frequency components closely, and, therefore, the frequency components of decoded speech signals acquired in the decoder are concentrated in the low band. Consequently, the spectrum of the synthesized signal outputted from adding section 154 does not show growth in the high frequency components and becomes weaker from around 5 kHz. This is the situation in the layered codec that frequently happens in layers where the sampling frequencies change significantly.

FIG. 3E shows characteristics of filter 156 for filling the high frequency components of the synthesized signal shown in FIG. 3D. With the present example, the cutoff frequency of filter 156 is about 6 kHz.

FIG. 3F shows the spectrum acquired as a result of filtering in filter 156 shown in FIG. 3E decoded speech signal A outputted from band extending section 155 shown in FIG. 3C. As shown in FIG. 3F, the high frequency components of decoded speech signal A are extracted by filtering. Further, although FIG. 3F shows the spectrum for ease of explanation, this filtering is processing carried out in the time domain and the resulting signal is a time sequence signal.

FIG. 3G shows the spectrum of decoded speech signal B outputted from adding section 157 and the spectrum in FIG. 3G is acquired by filling the spectrum of the synthesized signal shown in FIG. 3D with the high frequency components shown in FIG. 3F. In comparison of the spectrum in FIG. 3G and the spectrum of the input speech signal of FIG. 3A, although there is a difference in the high frequency band, the low frequency components are similar. Further, the high frequency components are filled and, consequently, the high frequency components stretch, so that it is possible to produce high band sensation and perceptually high-quality sound. Further, although FIG. 3G shows the spectrum for ease of explanation, this filling processing is carried out in the time domain.

Here, experiments show that, in case where the high frequency components are simply filled or in case where band extension is performed by complex processing using the low frequency components acquired in an upper layer, there is little difference in the quality of the decoded speech that is acquired in the end. This is because the algorithm for band extension itself is configured to copy low frequency components and roughly control power, the high frequency components acquired as a result of band extension and the high frequency components of the input speech signal are different, and so what is acquired is consistently an increase in “perceptual” high band sensation. Accordingly, particularly when the band extension technique is utilized in a lower layer, it is possible to increase quality as the band extension technique is actually used, by filling the band components in an upper layer by the present invention.

In this way, with the present embodiment, without band extension encoding, transmission of encoding information and band extension processing in an upper layer of the layered codec, it is possible to fill the high frequency components by simple processing and produce good synthesized speech having perceptual high band sensation in the upper layer.

Further, by adopting processing of adding the high frequency components as in the present embodiment, there is no concern that annoying sound is produced. This is because, if there is no annoying sound in the synthesized signal outputted from adding section 154 and no annoying sound in the high frequency components outputted from filter 156, annoying sound is not produced in the sound adding the synthesized signal and the high frequency components.

Further, although, with the present embodiment, processing of adding the high frequency components outputted from filter 156 to the synthesized signal outputted from adding section 154, the present invention is not limited to this, and, for example, the high frequency components outputted from filter 156 may be substituted for the high frequency components of the synthesized signal outputted from adding section 154. In this case, in cases where the high frequency components are added, it is possible to hedge the risk of increasing power of the high frequency band more than necessary. As explained above, according to the present embodiment, only the high frequency components in a lower layer are extracted by a high pass filter of a small amount of calculation and the high frequency components are filled in an upper layer, and, consequently, the decoder in the upper layer does not require processings of conversion in the frequency domain, copying of the frequency components and inversion in the time domain, so that it is possible to produce perceptually high-quality decoded speech with a small amount of calculation and a small number of bits. Further, the coder of the speech encoding apparatus for the upper layer does not need to transmit information for band extension.

Further, although an example has been explained with the present embodiment where speech decoding apparatus 150 receives and processes encoded data transmitted from speech encoding apparatus 100 as input, speech decoding apparatus 150 may receive as input and process encoded data outputted from encoding apparatuses that employ other configurations of generating encoded data including the same information.

Further, the speech decoding apparatus and the like according to the present invention are not limited to the above embodiment and can be implemented in various modifications. For example, the speech decoding apparatus is applicable to scalable configurations of two or more layers. All of scalable codecs that have been standardized, that have being studied for standardization or that are being practically used today, have greater numbers of layers. For example, the number of layers is twelve in ITU-T standard G729EV. When the number of layers is greater, it is possible to readily acquire synthesized speech that improves high band sensation, in many upper layers using information in a lower layer, thereby providing a greater advantage.

Further, although a case has been explained with the present embodiment where a band extension technique for high frequency components is used, when the band extension technique for low frequency components is used, the present invention provides the same performance by designing filter 156 to fill components of a band that is not encoded, as low frequency components.

Further, when lower layers and upper layers are assigned roles to encode different bands, the present invention can fill components of a band that is not encoded, in a lower layer and so is effective even when band extension is not used in a lower layer.

Further, although a case has been explained with the present embodiment where a bandpass filter is used as filter characteristics, the present invention is not limited to this and any filter is possible as long as it has characteristics of substantially outputting band components that could not be synthesized and outputting other band components little.

Further, although an example of layer encoding/decoding (i.e. scalable codec) has been explained with the present embodiment, the present invention is not limited to this and, for example, when a certain secondary codec is used and noise shaping (i.e. a method for collecting noise in a specific band and encoding it) is adopted upon encoding, the present invention may be used to cancel the band in which noise is collected.

Furthermore, the present embodiment does not mention changing filter characteristics, the present invention is able to improve performance by adaptively changing filter characteristics according to the characteristics of a decoder for an upper layer. As a specific method, a method may be possible for analyzing the power of a synthesized signal in an upper layer (i.e. output from adding section 154) and a synthesized signal in a lower layer (i.e. output from band extending section 155) on a per frequency basis and designing filter 156 to pass a frequency of when the power of the synthesized signal in the upper layer is weaker than the power of the synthesized signal in the lower layer.

An input signal from a encoding apparatus according to the present invention may be not only a speech signal but also an audio signal. A configuration may be possible where the present invention is applied to an LPC prediction residual signal of an input signal.

The encoding apparatus and decoding apparatus according to the present invention can be mounted in a communication terminal apparatus and base station apparatus in a mobile communication system, so that it is possible to provide a communication terminal apparatus, base station apparatus and mobile communication system providing same operations and advantages as described above.

Also, although cases have been described with the above embodiment as examples where the present invention is configured by hardware, the present invention can also be realized by software. For example, it is possible to implement the same functions as in the encoding apparatus/decoding apparatus according to the present invention by describing algorithms of the encoding method/decoding method according to the present invention using the programming language, and executing this program with an information processing section by storing in memory.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-322338, filed on Nov. 29, 2006, including the specification, drawings and abstract, is incorporated herein by reference in its entirety.

### INDUSTRIAL APPLICABILITY

The present invention is suitable for use in a decoding apparatus and the like in a communication system using a scalable coding technique.

1. A decoding apparatus that generates a decoded signal using two items of encoded data, the two items of the encoded data being acquired by encoding a signal comprising two frequency domain layers on a per layer basis, the decoding apparatus comprising:
a first decoding section that decodes the encoded data of a lower layer to generate a first synthesized signal;
a second decoding section that decodes the encoded data of an upper layer to generate a second synthesized signal;
an adding section that adds the first synthesized signal and the second synthesized signal to generate a third synthesized signal;
a band extending section that extends a band of the first synthesized signal to generate a fourth synthesized signal;
a filtering section that filters the fourth synthesized signal to extract predetermined frequency components; and
a processing section that processes predetermined frequency components of the third synthesized signal using the frequency components extracted by the filtering section.

2. The decoding apparatus according to claim 1, wherein the processing section adds the frequency components extracted in the filtering section to the third synthesized signal.

3. The decoding apparatus according to claim 1, wherein the processing section substitutes the frequency components extracted by the filtering section for the predetermined frequency components of the third synthesized signal.

4. A decoding method for generating a decoded signal using two items of encoded data, the two items of the encoded data being acquired by encoding a signal comprising two frequency domain layers on a per layer basis, the decoding method comprising:
decoding the encoded data of a lower layer to generate a first synthesized signal;
decoding the encoded data of an upper layer to generate a second synthesized signal;
adding the first synthesized signal and the second synthesized signal to generate a third synthesized signal;
extending a band of the first synthesized signal to generate a fourth synthesized signal;
filtering the fourth synthesized signal to extract predetermined frequency components; and
processing predetermined frequency components of the third synthesized signal using the frequency components extracted as a result of the filtering.
